(19) United States
(12) Patent Application Publication
(10) Pub. No.: US 2015/0004299 A1
(43) Pub. Date: Jan. 1, 2015

(54) BAKED CONFECTIONERY AND METHOD FOR MANUFACTURING SAME

(71) Applicant: Meiji Co., Ltd., Koto-ku, Tokyo (JP)

(72) Inventors: Takashi Katagiri, Tsurugashima-shi (JP); Goro Misaki, Tsurugashima-shi (JP); Saori Toriwa, Tsurugashima-shi (JP); Hiroyuki Utsunomiya, Tsurugashima-shi (JP)

(73) Assignee: MEIJI CO., LTD., Koto-ku, Tokyo (JP)

(21) Appl. No.: 14/377,044

(22) PCT Filed: Feb. 27, 2013
(86) PCT No.: PCT/JP2013/055086

§ 371 Date: Aug. 6, 2014

(30) Foreign Application Priority Data
Feb. 29, 2012 (JP) 2012-043851
Sep. 6, 2012 (JP) 2012-195895

(51) Int. Cl. A23G 1/48; A21D 8/06

(52) U.S. Cl. CPC A23G 1/48; A21D 8/06; A23V 2002/00
USPC 426/548; 426/660; 426/523

(57) ABSTRACT

Described herein is a baked confectionery which is produced by baking a fat-based confectionery comprising a nut, wherein the baked confectionery preferably comprises a compound selected from the group consisting of isomaltulose, mannitol, and maltitol. Also, described herein is a method for producing a baked confectionery, comprising preparing a fat-based confectionery comprising nuts and preferably also comprising a compound selected from the group consisting of isomaltulose, mannitol, and maltitol, and baking the fat-based confectionery.

### TECHNICAL FIELD

The present invention relates to a baked confectionery and a method for producing the same.

### BACKGROUND ART

Conventionally, there exist many combined chocolate confectionery in which edible solids are mixed with chocolate. For example, combinations of nuts and chocolate are favored by many consumers. However, in the case of confectionery in which chocolate and nuts are combined, a phenomenon that nuts whiten during storage occurs, and since such nuts look moldy, approaches to suppress the phenomenon have been taken.

### CITATION LIST

### Patent Literature

Patent Literature 1: WO No. 2011/115063

### SUMMARY OF INVENTION

### Technical Problem

Conventionally, a method for suppressing whitening of nuts by addition of liquid fats to chocolate dough has been adopted, but the melting point of chocolate is decreased by the method. Therefore, problems such as occurrence of stickiness when held in a hand, and a loss of a snapping mouthfeel when chocolate is bitten (referred to as a snap feeling) have arisen.

### Solution to Problem

Thus, as a result of intensive studies, the present inventors have made the present invention wherein a fat-based confectionery comprising nuts is baked to thereby suppress whitening of the nut during storage.

That is, the present invention provides the following:

(1) A baked confectionery produced by baking a fat-based confectionery comprising a nut.

(2) The baked confectionery according to (1), comprising a compound selected from the group consisting of isomaltulose, mannitol, and maltitol.

(3) The baked confectionery according to (2), wherein the content of isomaltulose, mannitol, or maltitol is from 3 to 25% by weight.

(4) The baked confectionery according to any one of (1) to (3), wherein the content of the nut is from 1 to 30% by weight.

(5) A method for producing a baked confectionery comprising preparing a fat-based confectionery comprising a nut and baking the fat-based confectionery.

(6) The method for producing the baked confectionery according to (5), wherein the baked confectionery comprises a compound selected from the group consisting of isomaltulose, mannitol, and maltitol.

(7) The method for producing the baked confectionery according to (6), wherein the content of isomaltulose, mannitol, or maltitol is from 3 to 25% by weight.

(8) The method for producing the baked confectionery according to any one of (5) to (7), wherein the content of the nut is from 1 to 30% by weight.

### Advantageous Effects of Invention

The baked confectionery of the present invention is novel confectionery in which whitening of nuts during storage is suppressed. Additionally, when containing one selected from the group consisting of isomaltulose, mannitol, and maltitol, novel baked confectionery is obtainable in which whitening of nuts during storage is more suppressed and which has a crunchy mouthfeel even in the center, a good mouthfeel due to combination with nuts, and no scorching flavor.

### DESCRIPTION OF EMBODIMENTS

### Raw Materials

The fat-based confectionery in the present invention widely means fat-based confectionery, and is not limited to the standardized chocolate dough. Any and all fat-based confectionery, such as chocolates and quasi chocolates defined in “Fair Competition Codes concerning Labeling on Chocolates”, rules certified by Japan Fair Trade Commission, and fat cream not corresponding to those can be used.

The baked confectionery in the present invention is confectionery produced by literally baking the fat-based confectionery in an oven and the like. The baking temperature is about 100° C. or more in terms of an internal temperature of an oven and the like. The baked confectionery of the present invention, which is fat-based confectionery comprising nuts, exhibits suppressed whitening of nuts and has a good mouthfeel and flavor due to baking.

In the present invention, the content of each ingredient of the fat-based confectionery is based on the weight of the entire confectionery after baking, unless otherwise noticed.

In the baked confectionery of the present invention, when a compound selected from the group consisting of isomaltulose, mannitol, and maltitol is contained, whitening of nuts during storage can be more suppressed, and therefore a shorter baking period can bring about an effect of suppressing whitening of nuts as well as a preferable mouthfeel and a flavor.

It is more preferable to contain 3 to 25% by weight of isomaltulose, 3 to 25% by weight of mannitol, or 3 to 25% by weight of maltitol in view of the effect of suppressing whitening of nuts during storage, which is an object of the present invention, as well as the mouthfeel and the flavor.

Furthermore, it is particularly preferable to contain 6 to 20% by weight of isomaltulose, 6 to 20% by weight of mannitol, or 6 to 20% by weight of maltitol in view of the effect of suppressing whitening of nuts during storage, which is an object of the present invention, as well as the mouthfeel and the flavor.

As the nuts in the present invention, almonds, macadamia nuts, peanuts, walnuts, pistachios, cashews, and hazelnuts and the like can be used.

In the baked confectionery of the present invention, the content of nuts is not limited, but 1 to 30% by weight is preferred.

Although nuts may be used without crushing in a form of so-called whole nuts, the effect of suppressing whitening of nuts is more suitably achieved in the case where crushed nuts on whose surface inside of nut appears, sliced nuts, shredded nuts, generally called slivered, and the like are used.

There is not particular limitation on the sizes of crushed nuts as long as the grains have visible sizes so that the effect of suppressing whitening of the present invention can be confirmed. Preferably, the size of the crushed nuts is from 0.5 mm to 10 mm, inclusive in diameter. More preferably, the size of the crushed nuts is from 1 mm to 5 mm, inclusive in diameter.

For sliced or shredded nuts having a major axis of more than 10 mm, the thickness is preferably from 0.5 mm or more to 5 mm or less.

Other raw materials are the same as those of the usual fat-based confectionery, and sugar, whole powdered milk, cacao mass, cocoa butter, vegetable fats, and lecithin can be used.

Also, glucides, dairy products, fats, salts such as common salt, pigments, emulsifiers, flavorings, and other ingredients can be used as required, as long as suitable for the goal of the present invention.

As the glucide, for example, sugars such as starch, pregelatinized starch, lactose, glucose, fructose, trehalose, dextrin, and cellulose, and sugar alcohols such as sorbitol can be used. Isomaltulose, mannitol, and maltitol are excluded from the glucides used here.

Examples of the dairy product include defatted powdered milk, cream powder, and dried whey.

Examples of the fats include tempering-type fats and non-tempering-type fats derived from animals or plants or both, or substitute fats obtained by mixing them, and particularly include sal fats, shea fat, palm fat, milk fat, DHA, EPA, shortening, and margarine.

Examples of the emulsifier include sucrose fatty acid esters and polyglycerol fatty acid esters.

Examples of the flavoring include vanillin and vanilla extracts.

### Production Method

The baked confectionery of the present invention can be produced as follows, for example.

For example, powder raw materials such as isomaltulose, mannitol, maltitol, sugar, lactose, whole powdered milk, defatted powdered milk, and cream powder, and liquid raw materials such as melted cacao mass, cocoa butter, vegetable fats, and lecithin are stirred and mixed so as to achieve an fat content suitable for refining (usually 25 to 30%) to thereby obtain a paste of starter dough.

The obtained starter dough is refined and formed into flakes, and the flakes are further liquefied into a paste by conching. Subsequently, fats as raw materials such as cocoa butter or vegetable fats, and lecithin are added to the paste so as to achieve the desired fat content and viscosity, and stirred and mixed to thereby obtain dough for fat-based confectionery.

Flavorings and the like may be further added to the obtained dough as required.

Then, nuts are stirred and mixed into the obtained fat-based confectionery dough. Instead of stirring and mixing nuts, nuts may be attached to the surface of the shaped fat-based confectionery dough so as to allow the nuts to be exposed.

Also, for example, in the case where whole nuts are used, the nuts may be immersed in a container filled with fat-based confectionery dough to coat the surfaces of the nuts with fat-based confectionery dough, or a revolving pan may be used to coat the surfaces of the nuts with the fat-based confectionery dough. The shaped nuts-containing fat-based confectionery dough may be cooled and solidified as required before used in the next step.

Subsequently, the obtained nuts-containing fat-based confectionery dough is baked in an oven and the like. In view of the flavor after baking, it is preferred that baking be performed at from 160 to 250° C.

Nuts whiten during storage of the obtained baked confectionery if baking is insufficient. Therefore in order to suppress whitening, it is necessary to perform baking so as to allow even the center to have a crunchy mouthfeel, and thus it is necessary to adjust the baking time depending on a baking temperature as appropriate.

It is preferred to make the thickness of fat-based confectionery dough portion to be 10 mm or less, which makes it easy to obtain baked confectionery that has been baked to have a crunchy mouthfeel even at the center thereby to particularly meet the goal of the present invention, achieving the effect of suppressing whitening of nuts during storage.

### EXAMPLES

Hereinbelow, the present invention is described more particularly referring to Examples, but the present invention is not intended to be limited to these.

Chocolate base dough (hereinbelow, referred to as base dough) was produced according to the formulation shown in Table 1.

TABLE 1

| Raw materials | Formulation ratio (%) |
|---|---|
| Cacao mass | 8.1 |
| Whole powdered milk | 38.1 |
| Sugar | 34.1 |
| Cocoa butter | 19.0 |
| Lecithin | 0.7 |
| Total | 100.0 |

### Test Examples 1 to 4

The obtained base dough, crushed almonds that passed a 7.5 mesh (opening: 2.3 mm) and left on a 12 mesh (opening: 1.4 mm), isomaltulose (trade name: palatinose, manufactured by Mitsui Sugar Co., Ltd.) or sugar, a liquid fat whose SFC (solid fat content) is 7 at 20° C. (trade name: MELANO SS, manufactured by Fuji Oil Co., Ltd.) or cocoa butter, and a seed agent (trade name: BOBstar, manufactured by Fuji Oil Co., Ltd.) were mixed in each formulation ratio shown in Table 2 to prepare fat-based confectionery dough, and then the obtained fat-based confectionery dough was shaped into a form having a length of 28 mm, a width of 28 mm, and a thickness of 3 mm, followed by baking in an oven at 200° C. with setting the baking time to 4, 7, or 9 minutes to thereby obtain baked confectionery.

TABLE 2

| | Test | Test | Test | Test |
|---|---|---|---|---|
| | Example 1 | Example 2 | Example 3 | Example 4 |
| Base dough | 73 | 73 | 73 | 73 |
| Crushed almonds | 5 | 5 | 5 | 5 |
| Isomaltulose | 15 | 15 | — | — |
| Sugar | — | — | 15 | 15 |
| Liquid fat | 4 | — | 4 | — |
| Cocoa butter | — | 4 | — | 4 |
| Seed agent | 3 | 3 | 3 | 3 |
| Total | 100 | 100 | 100 | 100 |

The obtained baked confectionery and the unbaked fat-based confectionery were subjected to temperature cycles at 20 to 30° C. with a frequency of two cycles/day for 10 days, and then, stored at 20° C. for 24 hours. After that, the whitening condition of nuts contained in the baked confectionery and the unbaked fat-based confectionery was observed. The result is shown in Table 3. Also, organoleptic evaluation was conducted on the baked confectionery and the unbaked fat-based confectionery of each test group. The result is shown in Table 4.

As for the shelf-life test of the baked confectionery with the formulation of Test Examples 1 and 2 which had been baked for 7 minutes, whitening of nuts was not observed, which was good. Furthermore, there was an entirely crunchy mouthfeel, which was a preferable mouthfeel. In contrast, as for the shelf-life test of the baked confectionery with the formulation of Test Examples 3 and 4 which had been baked for 7 minutes, whitening of nuts was observed in part, but the effect of suppressing whitening of nuts due to baking was able to be confirmed. Also, there was an entirely crunchy mouthfeel, which was a preferable mouthfeel. Additionally, as for the shelf-life test of the baked confectionery with the formulation of Test Examples 3 and 4 which had been baked for 9 minutes, whitening of nuts was not observed, but there was too crunchy a mouthfeel, which was left in the mouth, and there was a scorching bitter taste, which was not preferred.

TABLE 3

| Baking time | Test | | Test | |
|---|---|---|---|---|
| (minutes) | Example 1 | Test Example 2 | Example 3 | Test Example 4 |
| Unbaked | D | D | D | D |
| 4 | B | B | C | C |
| 7 | A | A | B | B |
| 9 | A | A | A | A |

D Nuts intensively whitened overall.
C Nuts whitened overall.
B Whitening was observed in part of the nuts.
A Whitening of nuts was not observed.

TABLE 4

| Baking time | | Test | | Test |
|---|---|---|---|---|
| (minutes) | Test Example 1 | Example 2 | Test Example 3 | Example 4 |
| Unbaked | C | C | C | C |
| 4 | B | B | B | B |
| 7 | A | A | A | A |
| 9 | D | D | D | D |

C There was a conventional chocolate mouthfeel.
B The surface had a crispy mouthfeel, but the center had a conventional chocolate mouthfeel.
A Both the surface and the center were crunchy, and had a preferable mouthfeel and flavor.
D There was too crunchy a mouthfeel, which was left in the mouth, and there was a scorching bitter taste, which was not preferred.

### Test Examples 5 to 8

Baked confectionery with the formulation ratio shown in Table 5 and each baking condition was obtained according to the same procedure as that of Test Examples 1 to 4, except that crushed almonds were sprinkled on the top of the shaped fat-based confectionery dough so as to allow all the crushed almonds to be exposed on the top, instead of mixing crushed almonds with each ingredient.

TABLE 5

| | Test | Test | Test | Test |
|---|---|---|---|---|
| | Example 5 | Example 6 | Example 7 | Example 8 |
| Base dough | 73 | 73 | 73 | 73 |
| Crushed almonds | 5 | 5 | 5 | 5 |
| Isomaltulose | 15 | 15 | — | — |
| Sugar | — | — | 15 | 15 |
| Liquid fat | 4 | — | 4 | — |
| Cocoa butter | — | 4 | — | 4 |
| Seed agent | 3 | 3 | 3 | 3 |
| Total | 100 | 100 | 100 | 100 |

The obtained baked confectionery and the unbaked fat-based confectionery were subjected to temperature cycles at 20 to 30° C. with a frequency of two cycles/day for 10 days, and then, stored at 20° C. for 24 hours. After that, the whitening condition of nuts contained in the baked confectionery and the unbaked fat-based confectionery was observed. The result is shown in Table 6. Also, organoleptic evaluation was conducted on the baked confectionery and the unbaked fat-based confectionery of each test group. The result is shown in Table 7.

As for the shelf-life test of the baked confectionery with the formulation of Test Examples 5 and 6 which had been baked for 7 minutes, whitening of nuts was not observed, which was good. Furthermore, there was a crunchy mouthfeel overall, which was a preferable mouthfeel. In contrast, as for the shelf-life test of the baked confectionery with the formulation of Test Examples 7 and 8 which had been baked for 7 minutes, whitening of nuts was observed in part, but the effect of suppressing whitening of nuts due to baking was able to be confirmed. Also, there was an entirely crunchy mouthfeel, which was a preferable mouthfeel. Additionally, as for the shelf-life test of the baked confectionery with the formulation of Test Examples 7 and 8 which had been baked for 9 minutes, whitening of nuts was not observed, but there was too crunchy a mouthfeel, which was left in the mouth, and there was a scorching bitter taste, which was not preferred.

TABLE 6

| Baking time | Test | Test | Test | Test |
|---|---|---|---|---|
| (minutes) | Example 5 | Example 6 | Example 7 | Example 8 |
| Unbaked | D | D | D | D |
| 4 | B | B | C | C |
| 7 | A | A | B | B |
| 9 | A | A | A | A |

D Nuts intensively whitened overall.
C Nuts whitened overall.
B Whitening was observed in part of the nuts.
A Whitening of nuts was not observed.

TABLE 7

| Baking time | Test | Test | Test | Test |
|---|---|---|---|---|
| (minutes) | Example 5 | Example 6 | Example 7 | Example 8 |
| Unbaked | C | C | C | C |
| 4 | B | B | B | B |
| 7 | A | A | A | A |
| 9 | D | D | D | D |

C There was a conventional chocolate mouthfeel.
B The surface had a crispy mouthfeel, but the center had a conventional chocolate mouthfeel.
A Both the surface and the center was crunchy, and had a preferable mouthfeel and flavor.
D There was too crunchy a mouthfeel which was left in the mouth, and there was a scorching bitter taste, which was not preferred.\

### Test Examples 9 to 11

Except that mannitol (trade name: Marine Crystal, manufactured by Mitsubishi Shoji Foodtech Co., Ltd.) or maltitol (trade name: Mabit, manufactured by Hayashibara Co., Ltd.) was used instead of isomaltulose, and that almond slices having a major axis of 20 mm, a minor axis of 10 mm, and a thickness of 1 mm were placed on the shaped confectionery dough to achieve the formulation ratio shown in Table 8 instead of mixing crushed almonds with other ingredients, baked confectionery were obtained according to the same procedure as that of Test Examples 2 and 4.

TABLE 8

| | Test Example 9 | Test Example 10 | Test Example 11 |
|---|---|---|---|
| Base dough | 73 | 73 | 73 |
| Sliced almonds | 5 | 5 | 5 |
| Mannitol | 15 | — | — |
| Maltitol | — | 15 | — |
| Sugar | — | — | 15 |
| Cocoa butter | 4 | 4 | 4 |
| Seed agent | 3 | 3 | 3 |
| Total | 100 | 100 | 100 |

The obtained baked confectionery and the unbaked fat-based confectionery were subjected to temperature cycles at 20 to 30° C. with a frequency of two cycles/day for 10 days, and then, stored at 20° C. for 24 hours. After that, the whitening condition of nuts contained in the baked confectionery and the unbaked fat-based confectionery was observed. The result is shown in Table 9. Also, organoleptic evaluation was conducted on the baked confectionery and the unbaked fat-based confectionery of each test group. The result is shown in Table 10.

As for the shelf-life test of the baked confectionery with the formulation of Test Examples 9 and 10 which had been baked for 7 minutes, whitening of nuts was not observed, which was good. Furthermore, there was an entirely crunchy mouthfeel, which was a preferable mouthfeel. In contrast, as for the shelf-life test of the baked confectionery with the formulation of Test Example 11 which had been baked for 7 minutes, whitening of nuts was observed in part, but the effect of suppressing whitening of nuts due to baking was able to be confirmed. Also, there was an entirely crunchy mouthfeel, which was a preferable mouthfeel. Additionally, as for the shelf-life test of the baked confectionery with the formulation of Test Example 11 which had been baked for 9 minutes, whitening of nuts was not observed, but there was too crunchy a mouthfeel as if the confectionery was left in the mouth, and there was a scorching bitter taste, which was not preferred.

TABLE 9

| Baking time | | Test Example | Test Example |
|---|---|---|---|
| (minutes) | Test Example 9 | 10 | 11 |
| Unbaked | D | D | D |
| 4 | B | B | C |
| 7 | A | A | B |
| 9 | A | A | A |

D Nuts intensively whitened overall.
C Nuts whitened overall.
B Whitening was observed in part of the nuts.
A Whitening of nuts was not observed.

TABLE 10

| Baking time | | Test Example | Test Example |
|---|---|---|---|
| (minutes) | Test Example 9 | 10 | 11 |
| Unbaked | C | C | C |
| 4 | B | B | B |
| 7 | A | A | A |
| 9 | D | D | D |

C There was a conventional chocolate mouthfeel.
B The surface had a crispy mouthfeel, but the center had a conventional chocolate mouthfeel.
A Both the surface and the center were crunchy, and had a preferable mouthfeel and flavor.
D There was too crunchy mouthfeel, which was left in the mouth, and there was a scorching bitter taste, which was not preferred.

1. A baked confectionery produced by baking a fat-based confectionery comprising a nut.

2. The baked confectionery according to claim 1, comprising a compound selected from the group consisting of isomaltulose, mannitol, and maltitol.

3. The baked confectionery according to claim 2, wherein the content of isomaltulose, mannitol, or maltitol is from 3 to 25% by weight.

4. The baked confectionery according to claim 1, wherein the content of the nut is from 1 to 30% by weight.

5. A method for producing a baked confectionery comprising preparing a fat-based confectionery comprising a nut and baking the fat-based confectionery.

6. The method for producing the baked confectionery according to claim 5, wherein the baked confectionery comprises a compound selected from the group consisting of isomaltulose, mannitol, and maltitol.

7. The method for producing the baked confectionery according to claim 6, wherein the content of isomaltulose, mannitol, or maltitol is from 3 to 25% by weight.

8. The method for producing the baked confectionery according to claim 5, wherein the content of the nut is from 1 to 30% by weight.

9. The baked confectionery according to claim 2, wherein the content of the nut is from 1 to 30% by weight.

10. The baked confectionery according to claim 3, wherein the content of the nut is from 1 to 30% by weight.

11. The method for producing the baked confectionery according to claim 6, wherein the content of the nut is from 1 to 30% by weight.

12. The method for producing the baked confectionery according to claim 7, wherein the content of the nut is from 1 to 30% by weight.
